(19) United States
(12) Patent Application Publication
(10) Pub. No.: US 2012/0060574 A1
(43) Pub. Date: Mar. 15, 2012

(54) PLANTING MIX COMPOSITIONS AND METHODS

(75) Inventor: Bill L. Rose, Hubbard, OR (US)

(73) Assignee: Rose Agri-Seed, Inc.

(21) Appl. No.: 13/211,202

(22) Filed: Aug. 16, 2011

Related U.S. Application Data
(60) Provisional application No. 61/374,164, filed on Aug. 16, 2010.

(51) Int. Cl. C05F 11/00; B32B 27/06; B05D 1/36; B32B 5/16

(52) U.S. Cl. 71/23; 428/403; 428/407; 427/201

(57) ABSTRACT

This application provides compositions that include pelletized coir with seed and charcoal attached to the surface thereof and methods of making such compositions. In particular examples, such compositions include pelletized coir at least partially coated with a binder, seeds, charcoal, and optionally a super-absorbent polymer (SAP).

### CROSS-REFERENCE TO RELATED APPLICATION

This application claims priority to U.S. Application No. 61/374,164 filed Aug. 16, 2010, herein incorporated by reference.

### FIELD

This application relates to planting mix compositions and methods of preparing such compositions that prepare seed for planting, such as compositions that include pelletized coir at least partially coated with a binder, seed, charcoal, and optionally a super-absorbent polymer (SAP).

### BACKGROUND

Several benefits of treating planting seed have been reported. For example, seeds can be coated to protect and enhance the environment surrounding the natural seed coat. Coating a seed can increase seed germination, improve seedling growth rate, and provide protection during dry spells until growth is established. When planting small seeds, such as bentgrass, at low planting rates, increasing the bulk greatly facilitates accurate seed placement. Seed coatings have been used as carriers for a variety of components, such as agrochemicals, nutrients, and plant growth regulators. In addition, seeds can be treated to reduce incidences of stand loss due to diseases and insects.

The germination of a coated seed is dependent on the seed absorbing moisture after sowing and cracking the coating to allow light and moisture. If the coated layer is not cracked, or it is cracked only with a small width and the seed is not exposed to a satisfactory amount of light, germination will be inhibited. Therefore, compositions are needed that can in some examples increase moisture available to a seed.

### SUMMARY

Seeds are routinely coated to improve seed ‘plant-ability’ and to incorporate seed treatment chemicals and nutrients so they are immediately available to the young seedlings. Maintaining optimum moisture levels can increase the germination of seed. The inventor has found that applying seeds and charcoal to the surface of pelletized coir (for example as opposed to putting the seeds within the coir), and in some examples further including a super-absorbent polymer (SAP), provides an unexpectedly superior environment for germination. For example, the germination of the seeds can be increased, for example as evidenced by one or more of increased germination rate, earlier seed germination, increased crop growth, or increased crop production.

Provided herein are compositions that include pelletized coir at least partially coated with seeds and charcoal adhered to the pelletized coir by a binder. In some examples the pelletized coir can further include a super-absorbent polymer (SAP) adhered to the pelletized coir by a binder. In some examples, the seeds on the coir surface are at least partially coated with a SAP, such as a starch-based SAP. In one example the binder is an at least partially water-soluble binder, such as polyvinyl alcohol (PVOH) or lignosulfanate. In some examples, the composition further includes compost. In particular examples, the pelletized coir does not have cavities greater in diameter than the diameter of the seed, for example cavities generated by a machine for the purpose of creating a cavity that can hold the seed, which can then be covered. Any seed can be used, such as grass seeds, wildflower seeds, vegetable seeds, or other crop seed. In particular examples, when compared to normal raw seed plantings, the disclosed compositions are 300-400% more successful (e.g., increased germination and earlier germination). The disclosed compositions can be packaged, for example placed into seed bags and the like.

Also provided are methods of making a planting mix. In particular examples the methods include adhering seed and charcoal to pelletized coir using a binder (such as a water-soluble binder), thereby generating a planting mix. The method can further include adhering SAP to pelletized coir using a binder. In some examples, seed to be adhered to the pelletized coir is at least partially coated with a SAP (and in some examples also with a binder). The method can further include generating the pelletized coir, for example by grinding blocks of coir to achieve at least 10 lb/bushel density (such as at least 20 lb/bushel density, at least 30 lb/bushel density, for example 12-20 lb/bushel density or 20-40 lb/bushel density), thereby generating ground coir; and milling the ground coir (for example in a California pellet mill) to densify the ground coir, for example to achieve at least 40 lb/bushel density (such as at least 45 lb/bushel density, at least 50 lb/bushel density, for example 40 to 80 lb/bushel density or 40 to 60 lb/bushel density), thereby generating pelletized coir. In particular examples, the method does not include compressing the seeds with the coir (which may kill the seeds); instead the coir is compressed and the seeds subsequently adhered to the pelletized coir. In particular examples, the method does not include introducing cavities into the coir, for example using a machine to introduce cavities or wells about the size of the seed, into which seed can be added, and the cavity closed or sealed. In particular examples, the method further includes planting the coated seed-coated bulking agent mixture, thereby improving germination of the seed in the mixture.

The disclosed compositions can be used under drought conditions on range lands or considerable rocky soils. The disclosed seed-coated pellets of coir containing SAP for moisture retention, provides an environment that enables establishment and suitable stands of grass, which would be impossible by currently known methods.

The foregoing and other objects and features of the disclosure will become more apparent from the following detailed description, which proceeds with reference to the accompanying figures.

### BRIEF DESCRIPTION OF THE DRAWINGS

FIG. 1 is a digital image of a germinated planting mix containing ryegrass seeds adhered to pelletized coir 14 days after planting.

FIG. 2 is a digital image of a germinated planting mix containing perennial ryegrass seeds adhered to pelletized coir. The seed-coated coir was planted on April 15 by pressing the seed-coated coir into snow in Alberta Canada. The image was obtained on July 22.

FIG. 3 is a digital image of a germinated planting mix containing perennial ryegrass seeds adhered to pelletized coir. The seed-coated coir was planted on May 8 by placing the seed-coated coir on the surface of dry soil (the soil was dry for at least 1 inch below the pellet surface) in Alberta Canada. The image was obtained on July 22.

### DETAILED DESCRIPTION

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. For example, the term “comprising a seed” includes single or plural seeds and encompasses the phrase “comprising at least one seed.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements.

Unless explained otherwise, all technical and scientific terms used herein have the same meaning as commonly understood by one of ordinary skill in the art to which this disclosure belongs.

Binder: A material used to adhere one agent to another, for example adhere SAP to seed or seed to pelletized coir. In particular examples, a binder provides a moist environment thereby allowing attachment of another agent, such as SAP or charcoal to seed; or seed, charcoal, or SAP to pelletized coir. A particular non-limiting example of a binder is an at least partially water soluble binder, such as polyvinyl alcohol (PVOH) or lignosulfanate.

Coir: The coarse fiber found between the husk and the outer shell of a coconut. Coir can be used as a bulking agent to absorb moisture. For example, seed can be attached to the outer surface or coir that has been pelletized, for example to improve the physical handling properties of the seed, for example water retention, flowability, water infiltration, drainage, aeration and structure. In some examples, coir is in a crushed, object, particle or granular form. Pelletized coir refers to coir that is ground and pelletized, such as a size of about 5 mm diameter, for example about 5 mm length×5 mm diameter or 5 mm diameter×10 mm length.

Coating: To apply a material to the outer surface of an agent. In particular examples, includes applying a material to the outer surface of a coir pellet or the outer surface of seed. However, coating does not require 100% coverage of the surface of the agent; partial coverage can be sufficient. For example, coating can in some examples result in coverage of at least 1% of the surface by the material, such as at least 10%, at least 20%, at least 50%, at least 80%, at least 95%, or at least 99% coverage of the surface of the desired (such as a coir pellet or seed surface).

A coating material can be directly applied to the agent (for example by incubating the coating material with the agent to be coated), or indirectly applied (for example by adhering a first material to the surface of the agent to be coated that permits attachment of a second material, and then adhering the second material to the agent already coated with the first material).

In one particular example, coating does not result in significant or any penetration of the covering or coating into the agent, such as penetration of a seed or coir pellet. In some examples, the thickness of a coating applied is at least 0.01 mm, for example at least 0.05 mm, such as about 0.01 mm to 0.1 mm. In particular examples, coating an agent alters the properties of the agent, for example to increase the ability of the agent to retain or absorb moisture.

Germination: The sprouting of a plant seed into a seedling, for example from a grass seed into a plant.

Germination rate: The proportion of seeds in a given batch or lot of seed that germinate. For example, a germination rate of 50% indicates that about 50% of the seeds in the batch will germinate when planted under conditions that permit germination.

Seed: The ripened ovule of gymnosperm or angiosperm plants, and includes the embryo and its proper coats and can also include the seed coat (an outer protective covering). Seeds are very diverse in size and shape. The disclosure is not limited to particular plant seeds, and can include for example grass seeds (such as a perennial ryegrass, fescue (such as tall fescue or hard fescue, for example Soil Guard hard fescue, Cowgirl tall fescue), bentgrass, Bermuda grass, smooth brome grass, seashore paspalum, or a switchgrass), flower seeds (such as wild flowers), tree seeds, vegetable seeds (such as tomato, lettuce, or cucumbers) or other crops (such as cotton seeds, soybeans, rapeseeds, and wheat). In a specific example, the seed is a grass seed.

Super-absorbent polymer (SAP): Materials that imbibe or absorb large quantities of aqueous fluid (such as water), for example at least 10 times their own weight, and that retain the imbibed or absorb aqueous fluid under moderate pressure. Generally, SAPs are water-insoluble polymers which swell or gel in aqueous fluids but do not dissolve in the fluids. Some SAPs can absorb 600 to 1000 times their weight in aqueous fluid. These polymers are typically lightly cross-linked polymers, which contain a multiplicity of acid functional groups such as carboxylic acid and carboxamide acid groups.

Exemplary SAPs include totally synthetic copolymers (such as those made by copolymerizing acrylic acid and acrylamide in the presence of a coupling agent), starch graft copolymers (such as those that use a natural polymer, such as starch to form an SAP product including a starch graft copolymer), and starch-based SAPs (such as those described in US Patent Application No. 2005/0159315, herein incorporated by reference as to the composition of the starch-based SAP, for example Zeba® available from Absorbent Technologies, Inc., Oregon).

In one example the SAP does not include starch. For examples the SAP can include or consist of acrylamide and/or potassium acrylate (such as Tramfloc® products, such as Tramfloc® 1001, 1002, 1009, 1153, 1158 or 1159).

### Plant Seed Compositions

The present disclosure provides plant seed compositions. In particular examples, such compositions include pelletized coir that has seed (such as seed at least partially coated with a SAP, such as Zeba®, and/or charcoal) and activated charcoal attached to the pelletized coir, for example attached thereto with polyvinyl alcohol (PVOH) or another binder or glue that does not substantially inhibit seed germination and aids in the establishment of plants in dry conditions. The attachment of a seed to an organic material such as coir permits the coated coir to hold moisture which is made available to the seed during germination, for example in climates that are dry. The charcoal imparts herbicide resistance to the seed. In some examples, the composition further includes other agents, such as r compost, resulting in an organic garden fertilizer with excellent germination.

In one example, the compositions include pelletized coir at least partially coated with seeds and charcoal adhered to the pelletized coir by a binder, and optionally, a super-absorbent polymer (SAP) adhered to the pelletized coir by a binder. In one example, the SAP is not a starch-based SAP. In some examples, the seeds adhered to the pelletized coir by a binder are at least partially coated with a super-absorbent polymer (SAP) and/or charcoal.

Exemplary binders include partially water-soluble binders, such as PVOH or lignosulfanate. Various ratios of the binder to pelletized coir can be present in the composition. In some examples, the binder and pelletized coir are present in the composition at a ratio of about 85% coir to 15% binder by weight, or about 50% each by weight (that is a ratio of about 1 to 1). In some examples, the pelletized coir:binder ratio in the composition is about 2 to 1, 3 to 1, 4 to 1, 5 to 1, 10 to 1, 15 to 1, 18 to 1, 20 to 1, 25 to 1, 30 to 1, 35 to 1, 36 to 1, 1 to 2, 1 to 3, 1 to 5, or 10 to 5 by weight. In a specific example, the pelletized coir:binder ratio is about 15 to 1 to 40 to 1, such as 18 to 1 to 36 to 1, by weight.

In one example, the ratio of the pelletized coir to the seeds is at least 3:1 by weight, such as at least 4:1, at least 5:1, at least 8:1, at least 10:1, at least 50:1 at least 100:1, at least 250:1 or at least 500:1 by weight, for example about 3:1, 4:1, 5:1, 8:1, 10:1, 47:1, 50:1, 100:1, 200:1, or 500:1 by weight. In some examples the coir:seed ratio is about 500:1 by weight (e.g., for Bermuda grass seed) or 47:1 by weight, (e.g., for smooth brome grass seed). In some examples the number of seeds per pellet is 1, 2, 3, 4, 5, 6, 7, 8, 9, or 10 seeds per pellet, such as 3 seeds/pellet to 5 seeds/pellet or 1 to 5 seeds per pellet. The disclosed compositions can include other agents, such as one or more growth-promoting additives, such as fertilizers, pesticides (such as a fungicide), growth hormones, soil-based nutrients, activated charcoal, compost, or combinations thereof, as well as colorants.

For example, inclusion of activated charcoal in the composition can increase the herbicide resistance of the seed, such as an increase of at least 10%, at least 25%, at least 50%, at least 75%, at least 90% or at least 99%. For example, when such compositions are planted, the crop or other seed- or plant-containing area can be treated with one or more herbicides to reduce undesirable weed growth, without significantly affecting the viability of the coated seeds. This results in a crop or other treated area that is virtually weed-free (for example less than 0.05% weeds, less than 0.5% weeds, or less than 0.1% weeds). In particular examples, activated charcoal can increase resistance to the following herbicides: atrazine, Karmex, and Kerb.

The pelletized coir can be generated from blocks of coir. For example, coir can be processed into smaller particles or granules or irregular pieces. For example, they can be ground or otherwise fragmented. For example, coir can be mechanically ground into smaller particles using methods known in the art, such as a hammermill or tub grinder. In some examples, the ground coir is pelletized in a California pellet mill in order to densify the coir. In some examples, the pelletized coir is screened to roughly the desired size (for example to remove smaller undesired coir pellets). In some examples, coir is ground and pelletized under conditions that result in a density of pelletized coir of at least 40 lb/bushel, at least 50 lb/bushel, such as 40 to 60 lb/bushel. In particular examples, the pelletized coir are about 1 mm to 10 mm in diameter, for example 3 mm to 6 mm in diameter, or 5 mm in diameter. In particular examples, the pelletized coir are about 5 mm in diameter and 5 mm to 10 mm in length.

In particular examples, the pelletized coir does not have cavities greater in diameter than the diameter of the seed. For example, the pelletized coir is not subjected to a treatment that purposefully introduces cavities or wells into which seed can be deposited, and then the cavity sealed or closed. Instead, the seeds are adhered to the outer surface of the pelletized coir, and are not within the pelletized coir or encased in the pelletized coir.

In some examples, the disclosed compositions increase germination of seed present in the composition, such as seed at least partially coated with SAP (which in some examples is adhered to the pelletized coir with a binder) (herein referred to as “coated seed”). In some examples, the seed adhered to the composition is at least partially coated with SAP (and in some examples also charcoal) prior to adhering it to the pelletized coir. In other examples, the seed adhered to the composition is at least partially coated with SAP when it is being adhered to the pelletized coir. In particular examples, seed present in the disclosed pelletized coir-containing compositions have increased germination, for example as compared to normal or “uncoated” seed or to coated seed in the absence of the other components of the composition, such as an increase in germination of at least 20%, at least 30%, at least 40%, at least 50%, at least 75%, or at least 100%. In some examples, increased germination is evidenced by one or more of increased germination rate, earlier seed germination, increased crop growth, or increased crop production. In particular examples, the coated seed present in the disclosed compositions has an increased germination rate, for example a germination rate that is at least 20%, at least 30%, at least 40%, at least 50%, at least 75%, or at least 100% greater than normal uncoated seed or to coated seed in the absence of the other components of the composition. In some examples, the seed present in the disclosed compositions has an earlier germination, for example a germination that is at least 1 day, at least 2 days, at least 3 days, at least 5 days, at least 7 days, or at least 14 days earlier than normal uncoated seed or to coated seed in the absence of the other components of the composition.

SAPs are agents that can absorb aqueous fluids and retain the fluid under moderate pressure, such as water-insoluble hydrogel-forming polymers which swell aqueous fluids but do not dissolve in the fluids. SAPs are known in the art, and the disclosure is not limited to particular SAPs. Examples of SAPs that can be used include but are not limited to cross-linked polyacrylamide polymers (such as Broadleaf P4, SANWET IM-300 and IM-1000, AQUASTORE, AGRIGEL, and GROWSOAK 400, seaweed based products (such as ALGINURE), starch graft copolymers, and starch-based SAPs. In a specific example, the SAP is a starch-based SAP, such as those described in US Application No. 2005/0159315 (herein incorporated by reference as to the starch-based SAP compositions), for example Zeba® (Absorbent Technologies, Inc., Oregon). The concentration of SAP to be used can be determined by those skilled in the art. In one example, the SAP adhered to the seed can include about 0.5% to 5% SAP or 1 to 5% SAP, such as 2 to 5%, 2.5 to 5%, 1.5 to 2.5%, or 3 to 5% SAP by weight of the seed. In one example, the SAP adhered to the pelletized coir can include about 0.5% to 5% SAP or 1 to 5% SAP, such as 2 to 5%, 2.5 to 5%, 1.5 to 2%, 1.5 to 2.5%, or 3 to 5% SAP by weight of the pelletized coir.

An adhesive or binder can be used to adhere the Zeba® coating or other SAP to the seed or pelletized coir, by creating a favorable moist surface for the SAP-containing composition (e.g., Zeba® powder and filler material). Because Zeba® is a superabsorbent product and absorbs water very readily, polyvinyl alcohol (PVOH) can be used as the binder (Celvol® or BF17). For example, a rate of 1.5 to 2.5 pounds of powder PVOH to 100 pounds of grass seed can be used to provide a sufficiently moist surface for the SAP-containing composition to adhere. In one example, raw seed is exposed to PVOH binder for 60 to 90 seconds at 70 to 90° F. (e.g., room temp) to obtain thorough coverage on each seed.

In some examples, the pelletized coir or coated seed can also include adhered activated charcoal. The activated charcoal can be adhered to the pelletized coir or seed along with the SAP or can be adhered to the seed via the binder in a separate step. In a particular example, the ratio of activated charcoal to seed is at least a 1:1 ratio by weight of charcoal to seed, for example at least a 2 to:1, at least 5 to 1, at least 10:1 at least 15 to 1, at least 20 to 1, at least 25 to 1 or at least 30 to 1 (such as a ratio of about 2 to 1, 4 to 1, 5 to 1, 10 to 1 or 29 to 1).

In one example, the ratio of pelletized coir to the seed adhered thereto is about 3:1 by weight, such as 4 to 1 by weight, about 5 to 1 by weight, or about 10 to 1 by weight.

In particular examples, the binder-coated pelletized coir contains at least 1 coated seed, such as at least 3, at least 5, or at least 10 seeds, such as 2, 3, 4, 5, 6, 7, 8, 9, 10, 12, 15, or 20 seeds. In some examples, the ratio of coir to seed is determined by the plant density desired in the field. For example, for tall fescue with a desired 1 plant per sq. foot (43,560 per acre) 2-3 seeds are applied per coir pellet, and to achieve 126,000 seeds per acre (there are 250,000 seeds/lb of seed), 1 to 1.5 lb seed per acre is need. For turf, to achieve one plant per sq. inch, with 4 seeds per pellet, approximately 144 pellets are planted per sq foot, thus 24 lbs pellets per 1000 sq feet.

The disclosure is not limited to particular seeds. Any plant seed can be adhered to pelletized coir by a binder. Exemplary seeds include those that can germinate into flowers, trees, grasses (such as fescue (for example fine and tall fescue), seashore paspalum, ryegrass, forage grass, switchgrass, Bermuda grass, smooth brome grass, and bluegrass), and those used to plant crops (such as soy, beans, cotton, tobacco, tomatoes, corn, melon, rye, carrots, lettuce, and wheat) or any seed that can benefit from this method. In a specific example the seed is a grass seed.

In a specific example, the composition includes seed at least partially coated with an alcohol-based binder (such as PVOH), to which a SAP-containing composition is adhered (such as a SAP-containing composition that includes 1 to 5% SAP, such as 1.5 to 1.5% SAP, for example Zeba®). In another specific example, the composition includes activated charcoal, for example a ratio of at least 1:1 (w/w) of activated charcoal to seed, such as a ratio of at least 2:1, at least 3:1, at least 5:1, at least 7:1 or at least 10:1 (w/w).

### Methods of Producing a Planting Mix

Methods of producing a planting mix are provided. In particular examples, the planting mix increases the germination of seed in the planting mix, such as an increase in the germination rate, an earlier germination date, or combinations thereof. Indications of increased germination include, but are not limited to, earlier seed germination or blooming, decreased irrigation requirements, increased germination, increased crop growth, increased crop production or yield, increased plant size, increased germination rate, or combinations thereof. For example, increased germination can be relative to naked seed (e.g., seed not adhered to pelletized coir) or to seed not containing SAP, such as an increase of at least 20%, at least 40%, at least 50%, at least 75%, at least 80%, at least 90% or at least 95%.

In particular examples, the method includes adhering seed and activated charcoal to pelletized coir using a binder, for example pelletized coir at least partially coated with a binder, thereby generating a planting mix. In particular examples, adhering the seed and activated charcoal to pelletized coir using a binder includes mixing the pelletized coir and then adding a first amount of binder to the pelletized coir. This can result in at least partial coating of the coir by the binder. Subsequently, seed is added to the binder-pelletized coir mixture. Charcoal is added to the seed-binder-pelletized coir mixture, followed by adding a second amount of binder. It is shown herein the addition of the components in this order enhances coating of the pelletized coir and attachment of the seeds and charcoal.

In particular examples, the method further includes adhering a super-absorbent polymer (SAP) to the pelletized coir using the binder.

In particular examples, the seed is at least partially coated with a super-absorbent polymer (SAP) prior to attaching the seed to the pelletized coir. In particular examples, adhering the SAP, seed, and activated charcoal to pelletized coir using a binder includes mixing the pelletized coir and then adding a first amount of binder to the pelletized coir. This can result in at least partial coating of the coir by the binder. Subsequently, seed is added to the binder-pelletized coir mixture. Charcoal is added to the seed-binder-pelletized coir mixture, followed by adding a second amount of binder. Subsequently, the SAP is added to the charcoal-seed-binder-pelletized coir mixture. It is shown herein the addition of the components in this order enhances coating of the pelletized coir and attachment of the seeds, SAP and charcoal.

The method can also include generating the pelletized coir, for example by grinding blocks of coir to achieve at least 15 lb/bushel density, such as at least 20 lb/bushel density, at least 25 lb/bushel density, or at least 30 lb/bushel density, such as about 15 to 30 lb/bushel density, thereby generating ground coir and compressing the ground coir (for example in a California pellet mill) to achieve at least 40 lb/bushel density, such as at least 50 lb/bushel density, at least 60 lb/bushel density, or at least 80 lb/bushel density, such as about 40 to 60 lb/bushel density, such as about 45 lb/bushel density.

In some examples, the method further includes adding compost or other agent described above to the planting mix (such as an insecticide or herbicide or colorant).

In particular examples, the method can further include planting the planting mix, thereby permitting germination of the seed and in some examples improving germination of the seed. Thus, the disclosed compositions can be planted, resulting in improved germination of the seed. In some examples, the planting mix is planted in an environment traditionally considered unfavorable for seed germination and growth, such as snow, mud, or on top of dry dirt. Based on the results presented herein, it is expected that the disclosed planting mixes can be broadcast from an aircraft where vehicle traffic is not possible because of excessive moisture (e.g., the planting mixes applied to muddy areas). Based on these results, it is expected that the disclosed coated pellets can be planted onto soils with high levels of trash and organic matter on the surface, left there to retain moisture, and will successfully germinate and establish. Similar methods can be used to plant the disclosed coated pellets onto hay and pasture that needs to be reseeded. Prior to broadcasting (planting) the areas to be planted can be treated with glyphosate to kill the previous crops or weeds.

As discussed above, in particular examples the pelletized coir does not have cavities greater in diameter than the diameter of the seed. Thus, in some examples the method does not include introducing cavities or wells into the coir, for example by a machine, for example cavities that are about the size of the seed. In some examples the seeds are not within the pelletized coir. Thus, in some examples, the method does not include compressing seeds are not compressed with the coir.

In particular examples, the ratio of the pelletized coir to the seeds is at least 3:1 by weight, such as at least 4:1, at least 5:1, at least 6:1, at least 7:1, at least 8:1, at least 9:1, at least 10:1, at least 40:1, at least 100:1, at least 250:1 at least 500:1, such as 10:1 to 500:1. In some examples the average number of seeds attached to the pelletized coir is 1, 2, 3, 4, 5, 6, 7, 8, 9, 10, 11, 12, 13, 14, 15, 16, 17, 18, 19, or 20 seeds, such as 1 to 10 or 3 to 5 seeds.

As discussed above, the disclosure is not limited to use of particular seeds. Seeds from any plant can be used. Exemplary seeds are described above. In addition, the seed can include a mixture of different types of seeds, such as a mixture of different grass seeds or different wildflower seeds. In a specific example, the seed is a grass seed grass seed or wildflower seed, such as perennial ryegrass, bluegrass, smooth brome grass, Bermuda grass, hard fescue, tall fescue, or switchgrass seeds. In one example, the seed is a mixture of seed, such as ‘Sea Spray’ (seashore paspalum) and Poa trivialis (shade tolerant bluegrass). In one example the seed is a crop seed.

As described above, binders known in the art can be used. In one example, the binder is water soluble. In specific examples the binder comprises PVOH or lignosulfansate.

Also as discussed above, the disclosure is not limited to use of particular SAPs. Any SAP can be used, as long as it is not significantly toxic to the seeds or plants. Exemplary SAPs are described above. For example, the SAP can be a starch-based SAP, such as Zeba®, or a non-starched based SAP. In a particular example, the seed and/or pelletized coir are at least partially coated with a binder to which a SAP can adhere. In particular examples, the SAPs are present in a SAP-containing composition that is incubated with the at least partially binder-coated seeds or pelletized coir, such as a composition that includes SAP at a concentration of 1 to 5% of the weight of the seed, such as 1% to 5%, 2 to 3% or 1.5 to 2.5% of the weight of the seed. In one example, the SAP adhered to the pelletized coir can include about 0.5% to 5% SAP or 1 to 5% SAP, such as 2 to 5%, 2.5 to 5%, 1.5 to 2%, 1.5 to 2.5%, or 3 to 5% SAP by weight of the pelletized coir. In some examples, the SAP-containing composition adhered to the seeds also further includes activated charcoal, for example a ratio of about 1:1 or 10:1 (w/w) of activated charcoal to seed. In some examples, an approximately equal weight of the SAP particles are adhered to an approximately equal weight of the seed.

In a particular example, the ratio of activated charcoal added to the seed added is at least a 1:1 ratio by weight of charcoal to seed, for example at least a 2 to:1, at least 5 to 1, at least 10:1 at least 15 to 1, at least 20 to 1, at least 25 to 1 or at least 30 to 1 (such as a ratio of about 2 to 1, 4 to 1, 5 to 1, 10 to 1 or 29 to 1).

In particular examples, the method of making a planting mix includes mixing the composition described above (such as those including the pelletized coir containing seeds and charcoal and/or SAP) with other agents, such as compost, thereby generating a planting mix.

In very specific examples, the method includes coating grass seed and pelletized coir at least partially with a binder (resulting in coated pelletized coir); adhering a SAP-containing composition (such as a composition that includes 1-5% SAP, for example 1.5%-2.5% SAP by weight of the seed, and in some examples optionally includes at least 1:1 (w/w) activated charcoal:seed) to the seed, and adhering the coated seed to the coated pelletized coir, thereby generating a planting composition. In particular examples, the same binder is adhered to the grass seed and the coir.

### Coating Seeds and Pelletized Coir

Methods of coating a seed and pelletized coir are known in the art. For example, commercially available coating equipment is capable of producing a coating on the seed and pelletized coir. Exemplary types of coating equipment are a ribbon/paddle blender, an inclined rotary pan-type, and a rotostat mixing chamber.

In particular examples, an adhesive or binder is first applied to the pelletized coir (or seeds if they are to be separately coated before adhering them to the coir) under conditions that permit at least partial coating of the pelletized coir (or seeds) with the binder. This will allow activated charcoal and seeds or other agent (such as a SAP) to adhere to the coated pelletized coir, or the coated seeds to adhere to the pelletized coated coir, for example by creating a favorable moist surface for the agent to adhere. For example, raw seed or pelletized coir can be exposed to the binder for a time sufficient to obtain at least partial coverage (for example at least 10%, at least 20%, at least 50%, at least 75%, at least 90%, or at least 99% coverage) on each pelletized coir (or seed) particle. Typically, exposure to the binder occurs at room temperature (such as about 20-30° C.). In particular examples, the raw seed or coir pellets are exposed to the binder for at least 10 seconds (e.g., enough to soften pellet, generally under 60 seconds), such as at least 20 seconds, at least 30 seconds, or at least 60 seconds, no more than 120 seconds, no more than 60 seconds, such as 10 to 90 seconds, 10 to 60 seconds, or 10 to 30 seconds.

In some examples, the binder material is inert to the seed, for example does not significantly impair seed germination. In particular examples, the binder is alcohol-based, and in some examples at least partially water soluble. Such binders are known in the art. Exemplary binders that can be used with the compositions and methods provided herein include polyvinyl alcohol (PVOH) or a similar material within the same class used in the seed coating industry (such as polyvinyl acetate and others within this category). Most binders, such as PVOH, come in a powder form which can be mixed into the appropriate solution before use. For example, PVOH adhesives, such as the powder products Celvol® (Celanese Corporation) and BF17 (Kel Chemical), are known in the art. Liquid versions of these products can be used if mixing a solution from the powder form is not desirable. Other exemplary binders include Soil Moist (JRM Chemical, Cleveland, Ohio) and lignosulfonate.

The amount of binder solution applied to the seeds and pelletized coir can affect the quality of the coating: too much binder will result in lumps, while inadequate amounts of binder will cause the coating to dust off, offer low durability and low buildup. Ideally, the adhesive will not impair seed germination, will give seeds or pelletized coir a durable coating when dry, and will be readily soluble in water.

In particular examples, the amount of binder added is about 1% to 10% in weight of the total seed or pelletized coir to be coated, such as about 1% to 5%, or about 1.5% to 2.5%. In some examples, the ratio of coir to binder added is at least 2:1, at least 10:1, at least 18:1, at least 20:1, at least 30:1, at least 36:1 or at least 40:1. In some examples, the larger the seed or pelletized coir to be treated, the higher the percentage of binder used. For example, using 5 to 6 pounds of PVOH to 100 pounds of alfalfa or grass seeds provides a sufficiently moist surface for the filler composition to adhere. Those skilled in the art appreciate how to determine optimal amounts of binder and moisture levels to use.

In some examples, the binder is added at two separate times during the coating process. For example, pelletized coir can be mixed with a fraction of the total amount of binder used (for example a first amount that is at least 30% at least 40%, at least 50%, at least 60%, at least 70%, at least 80%, or at least 90% of the total amount of binder to be added). This at least partially coats the coir with the binder. Subsequently seed and charcoal are added, allowing them to bind to the at least partially coated coir. Subsequently, the remaining portion of the binder is added (for example a second amount that is no more than 50%, no more than 40%, no more than 30%, no more than 20%, or no more than 10% of the total amount of binder to be added). If SAP is to be added, it can be added after the second amount of binder.

If seeds are to be pre-coated with SAP prior to adhering to the coir, the seeds, can be at least partially coated with binder and exposed to a SAP under conditions that permit SAPs to adhere to the seed, and in some examples also permits activated charcoal to adhere to the seed. In particular examples, the SAP-containing composition includes finely ground mineral material, which will adhere to the moist surface of the seed, thereby coating the seed. Among the exemplary particulate solids that can be included in the SAP-containing composition (which can be attached to seeds and/or pelletized coir) are calcium carbonate, clay, gypsum, bentonite, and dry diatomaceous earth.

If desired, other additives can be included in the SAP-containing composition to be applied to the seeds or pelletized coir, or added to the planting compositions provided herein. Particular examples include growth-promoting agents, such as agents that increase the survival rate and health of the young plants. Examples include nutrients, fertilizers, fungicides, herbicides, pesticides, trace elements, growth hormones or combinations thereof. Nutrients routinely used in commercial grass seed coatings include but are not limited to N, P, K, S, Fe and Zn. In acidic soils, lime coatings for seeds can be beneficial to seedling performance.

In a particular example, activated charcoal is also adhered to the binder on the pelletized coir (or seeds). For example, activated charcoal can be present alone or in the SAP-containing composition, for example present at a ratio of at least 1:1 (w/w) activated charcoal:seed, such a ratio of at least 2:1, at least 4:1, at least 10:1, or at least 29:1. Alternatively, activated charcoal can be adhered to pelletized coir (or seeds) separately from the SAP containing-composition. For example, the amount of activated charcoal exposed to the seeds can be an amount at least 4 times the weight of the seeds (for example, if the seeds weigh 100 lbs, 400 lbs of activated charcoal can be adhered to the seeds).

The pelletized coir or seed (which in some examples are at least partially-coated with a binder) can be mixed with a SAP-containing composition to adhere the SAP-containing composition to the seed. Methods that permit such binding are known in the art. For example, the seed can be tumbled (for example in a drum), and the SAP-containing composition slowly added, for example by applying the SAP-containing composition upon the seeds (such as by spraying). The equipment can be run until the seed is at least partially coated (such as at least 25%, at least 50%, at least 80%, at least 90%, or 100% coated), for example for at least 10 seconds, at least 30 seconds, at least 60 seconds, such as 10 to 90 or 10 to 60 seconds. Similar methods can be used to adhere activated charcoal to seeds.

If desired, the seed or pelletized coir can be colored with an agent (such as a pigment or dye) to identify the coated seed or coated pelletized coir. Ideally, the coloring agent will not significantly inhibit germination or other desirable biological activity of the seed. This colorant can be incorporated into the SAP-containing composition, or into the binder composition. Alternatively, the colorant can be applied after the seed or pelletized coir is coated. An exemplary colorant is aqua-blue. In some examples, if activated charcoal is adhered to the seeds, no additional colorant is added.

If desired, the SAP-containing composition on the seed or pelletized coir can be compacted onto the seed using methods known in the art. Such compacting can be performed to reduce the amount of coating ‘flaking off, for example during transit or handling of the seed or pelletized coir. For example, the coated seed or pelletized coir can be fed into a mechanism, such as an inclined drum, to compact the coating.

After the seed it attached to the pelletized coir the composition can be dried. For example, drying can significantly reduce imbibing of moisture by the seed, thereby reducing unwanted pre-germination. In addition, drying can rapidly draw-off moisture without using excessive heat (which can kill the seed). Methods of drying are known in the art, for example using a large fluid bed dryer or forced hot air system. Depending on the type of drying equipment, temperatures for drying can be as high as 180° F. for a short time, such as 1 to 5 minutes or 1 to 3 minutes.

After drying, the composition can be screened for size, and can be bagged. In particular examples, the composition can be screened using t mesh screens. The desired-sized particles can be selected, for example fine particulate can be discarded.

In particular examples, the total time to generated pelletized coir with seeds and charcoal (and optionally SAP) attached is about 10 to 20 minutes.

### Example 1

### Generation of Pelletized Coir Coated with Grass Seeds

This example describes methods used to take coir particles and adhere thereto Zeba® superabsorbent polymer particles and grass seeds. One skilled in the art will recognize that similar methods can be used to adhere any other seed to coated coir.

Coir was densified using the following processes. Blocks of coir 12″ square and 6″ in depth with a weight of approximately 10# each were used. The blocks were ground with a tub grinder and achieve 15-30 lb/bushel density. After pelletizing in a California pellet mill the coir product achieved a 55 lb/bushel density. Pelletized coir at 85% of desired end weight was incubated in a roto-stat at 55 RPM. A binder was added at 15% of desired end weight, such as 15% of the desired end weight of polyvinyl alcohol (PVOH). Binder was incubated with the coir for 10 seconds, or until coir pellets began to soften.

Grass seed was at least partially coated with PVOH (such as Celvol® (Celanese Corporation) or BF17 (Kel Chemical)) to adhere the Zeba® coating to the seed. A rate of 1 to 6 pounds of powder PVOH to 100 pounds of grass seed was used to provide a sufficiently moist surface for the Zeba® to adhere. The powered PVOH was mixed 1:1 with water, heated to 180° F. to dissolve the PVOH, and allowed to cool to 70° F. The raw seed was exposed to the PVOH binder for 5 to 10 seconds at room temperature to obtain thorough coverage on each seed piece using blending.

After coating the seed with PVOH, the seed was at least partially coated with Zeba®. Zeba® was adhered to the seed via a binder to increase the amount of moisture absorbed into the seed coating layer. With Zeba®, cracking will occur in 2 or 3 days, increasing the opportunities for light and moisture penetration and thereby providing greater chance of germination. Only a relatively small amount of Zeba® is needed to provide these benefits; Zeba® was applied at a rate of 1½% to 3% of the weight of the seed. While the seeds were being tumbled in a drum, the Zeba® was applied to the seeds. The seeds were tumbled with the Zeba® composition for about 5 to 10 minutes. This resulted in a coated seed (though 100% coverage by the Zeba® is not required).

The resulting coir pellets were then placed in a roto-stat where SAP-coated perennial ryegrass seeds were attached at a rate of 1 lb. of seed to 3 lb. of coir pellets, achieving 3-4 seeds per pellet under the following procedure. After allowing the binder to adhere to the pelletized coir, 15% of desired end weight of SAP-coated grass seed was added at an even rate for 20 seconds. The mixture was run for 20 seconds or until the majority of seed has adhered to the coir pellets. The coir-seed pellet was transferred to a dryer, and agitated regularly to avoid clumping and to avoid over heating of seed. The coir-seed pellet was dried until the product reached about 7.5% moisture.

### Example 2

### Planting and Germination of Coated Coir

This example describes methods used to plant the composition described in Example 1. One skilled in the art will recognize that similar methods can be used to plant and germinate similar compositions with other seeds.

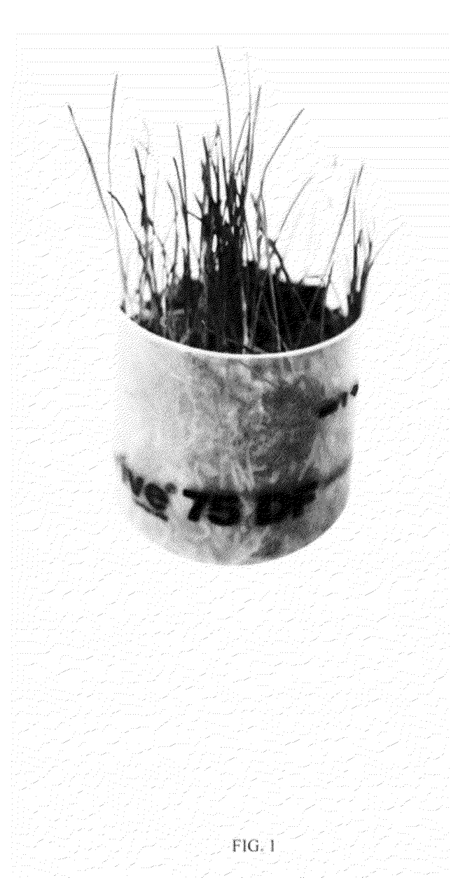

The coir-seed pellets generated in Example 1 were planted in soil and grown indoors with only moderate water. As shown in FIG. 1, the disclosed compositions provide an excellent environment for germination and establishment under dry conditions.

### Example 3

### Planting and Germination of Coated Coir in Northern Canada

This example describes methods used to plant and germinate pelletized coir coated with grass seeds in the snow. One skilled in the art will recognize that similar methods can be used to plant and germinate similar compositions with other seeds.

The coir-seed pellets were generated as described in experiment fourteen in Example 4. The coir included 3-5 perennial ryegrass seeds per pellet coated with charcoal. The pellets did not include a SAP. The pellet absorbs and retains large amounts of water, and the charcoal protects the seeds of germinating plants from chemicals used for weed control (e.g., glysophate).

In northern Canada, there is often difficulty achieving germination and establishment of forage and grass seeds. The perennial ryegrass-coated coir were planted in northern Alberta, Canada, on 1 foot centers. These pellets were planted into snow in the winter, in mud conditions, and on dry soil.

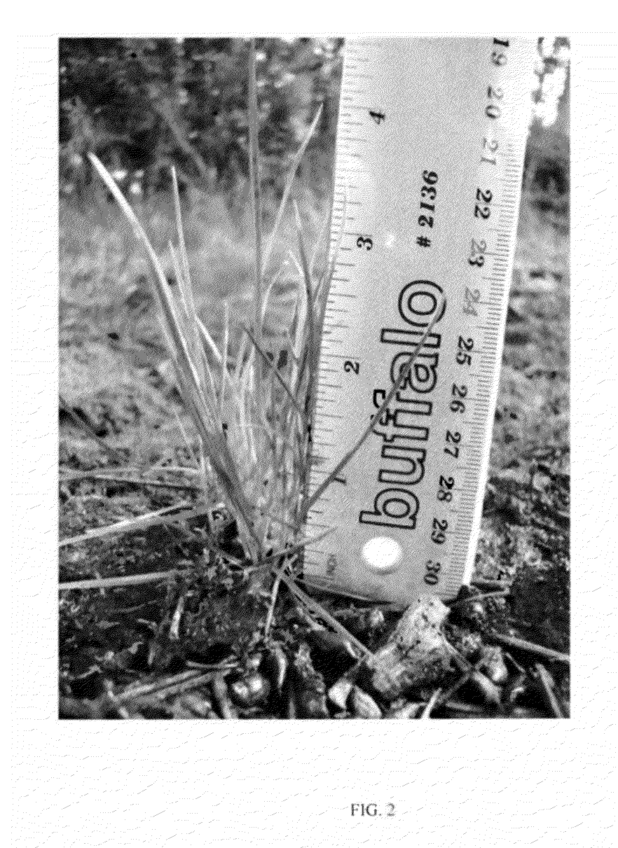

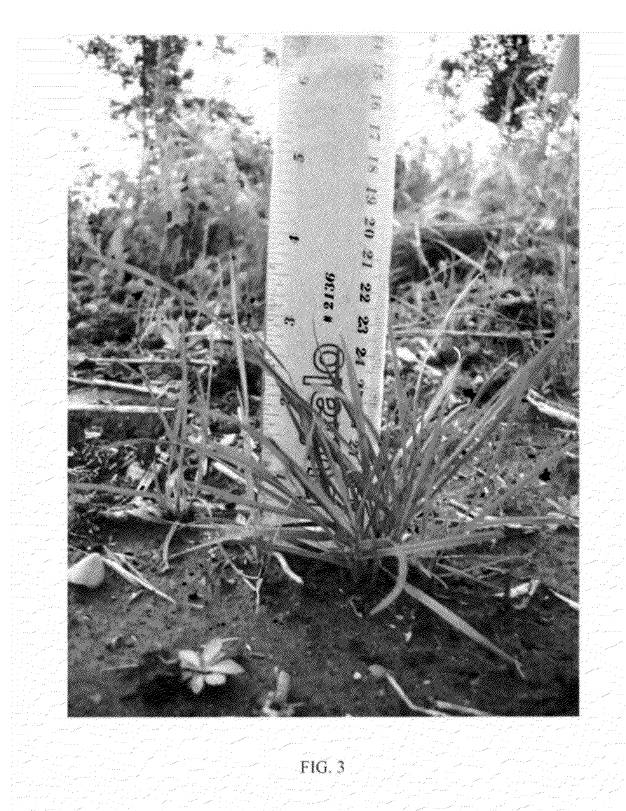

In all cases germination and establishment has been exceptional and far superior to seed planted alone. As shown in FIG. 2, 14 weeks after planting in snow, it was observed that the pellets produced a perfect stand of grass with no tillage and with early establishment. As shown in FIG. 3, similar results were achieved for pellets placed on a dry surface and left to germinate. Thus, the disclosed compositions enhance both germination and establishment.

Based on these results, it is expected that the use of the seed-coated coir will eliminate the need for tillage prior to planting, thereby reducing erosion and soil degradation. It is also expected that planting during out of season conditions, such as snow cover and extremely high moisture situations, will now be possible.

### Example 4

### Optimizing Coating Conditions

This example describes experiments used to optimize the coating conditions.

Bermuda grass seed (1.8 million seeds/lb or 3965 seeds/gram) can be applied to coir pellets (in some examples each pellet is about 0.454 grams) at a rate of about 3 seeds per pellet (220 pellets+660 seeds). Charcoal can be applied at a rate of 0.0218 grams of charcoal/pellet. This value is based on the rate of 300 lbs of charcoal per acre, typically used for grass fields. Zeba® is applied at 1.5-2.0% of pellet weight (0.4157 grams of Zeba®/pellet). Based on these calculations, 400 grams of pellets are contacted with 0.7279 grams Bermuda grass seed, 20.98 grams charcoal, in the presence or absence of Zeba® (if applied, 6 grams of Zeba® is used). This resulted in a final product of 400 grams pellets, 0.7279 grams seed, 20.98 grams charcoal and 6 grams of Zeba®.

In a first experiment, an adhesive was added (polyvinyl alcohol (PVOH)) at a charcoal:adhesive ratio of 3:1. 200 grams pellets were added to a Heid coater and spun at 15 rpm, diflectors at 3. 5.5 ml of 8% PVOH was injected (PVOH dissolved in water), and then immediately 15.5 grams fine powered charcoal added. This resulted in coated pellets, but not all of the charcoal stuck to the pellet (5.2 g of charcoal remained after screening off the coated pellets).

In a second experiment, twice as much adhesive was used. 200 grams pellets were added to a Heid coater and spun at 15 rpm, diflectors at 3. 11 ml of 8% PVOH was injected, and then immediately 15.5 grams fine powered charcoal added. This resulted in coated pellets, but not all of the charcoal stuck to the pellet as before (5.2 g fine dust charcoal (<1.44 mm) and 2.9 g of small charcoal granules (obtained with No. 8 screen)).

In a third experiment, the adhesive was added in two steps. 200 grams pellets were added to a Heid coater and spun at 15 rpm, diflectors at 3. 3.5 ml of 8% PVOH was injected, and then immediately 15.5 grams fine powered charcoal added, followed by 9.5 ml 8% PVOH. This resulted in charcoal not sticking to the pellet (20.6 g fine dust charcoal (<1.44 mm) and 2 g of small charcoal granules (>1.44 mm with No. 8 screen) remained).

In a fourth experiment, 200 grams pellets were added to a Heid coater and spun at 15 rpm, diflectors at 3. 3 ml of 8% PVOH was injected, and then immediately 15.5 grams fine powered charcoal added, followed by 5 ml 8% PVOH. This resulted in charcoal not sticking to the pellet (11.6 g fine dust charcoal (<1.44 mm) and 1 g of small charcoal granules (>1.44 mm with No. 8 screen) remained).

In a fifth experiment, the amount of charcoal was altered to 20.98 g charcoal/400 g pellets, so that on 200 g pellets, 10.49 g charcoal was used instead of 15.5 g charcoal. Zeba® and charcoal were pre-mixed, and then the PVOH added. The pellets used in experiment five were larger than experiments 1-4 (500 pellets/lb). 10.5 g charcoal was mixed with 3 g of Zeba®. 200 g of pellets were added to a Heid coater and spun at 15 rpm, diflectors at 3. 5.5 ml of 8% PVOH was injected, and then immediately the charcoal/Zeba® dry mix added. This resulted in charcoal not sticking to the pellet (12.2 g fine dust charcoal (<1.44 mm) and 0.7 g of small charcoal granules (>1.44 mm with No. 8 screen) remained).

In a sixth experiment, the adhesive was increased to 8 mls, and the charcoal and Zeba® added sequentially (no pre-mixing). 200 g of pellets (size of 500/lb) were added to a Heid coater and spun at 15 rpm, diflectors at 3. 8 ml of 8% PVOH was injected, and then immediately 10.5 g charcoal followed by 3 g Zeba® added. This resulted in a better result than the fifth experiment, but not as good as the first (which had no Zeba®). 11.6 g fine dust charcoal (<1.44 mm) and 1.5 g of small charcoal granules (>1.44 mm with No. 8 screen) remained.

In a seventh experiment, seed was included. 200 g of pellets (size of 500/lb) were added to a Heid coater and spun at 15 rpm, diflectors at 3. 8 ml of 8% PVOH was injected, and then immediately 0.364 g of Bermuda grass seed (R6WL) was added, followed by 10.5 g charcoal followed by 3 g Zeba®. This resulted in good coating of the pellets, but charcoal dust remained (6.5 g fine dust charcoal (<1.44 mm) and 0.8 g of small charcoal granules (>1.44 mm with No. 8 screen) remained.

In a eighth experiment, more adhesive was included. 200 g of pellets (size of 500/lb) were added to a Heid coater and spun at 15 rpm, diflectors at 3. 8 ml of 8% PVOH was injected, and then immediately 0.364 g of Bermuda grass seed (R6WL), followed by 10.5 g charcoal, followed by 3 ml 8% PVOH, followed by 3 g Zeba®, were added. This resulted in good coating of the pellets. 10.6 g fine dust charcoal (<1.44 mm) and 1.3 g of small charcoal granules (>1.44 mm with No. 8 screen) remained.

In a ninth experiment, a different Bermuda grass seed was used. 200 g of pellets (size of 500/lb) were added to a Heid coater and spun at 15 rpm, diflectors at 3. 8 ml of 8% PVOH was injected, and then immediately 0.364 g of Bermuda grass seed (R65B), followed by 10.5 g charcoal, followed by 3 ml 8% PVOH, followed by 3 g Zeba®, were added. This resulted in good coating of the pellets, with only a small amount of charcoal dust and aggregates remaining (3.4 g fine dust charcoal (<1.44 mm) and 2.7 g of small charcoal granules (>1.44 mm with No. 8 screen) remained).

In a tenth experiment, a different Bermuda grass seed and larger pellets were used. 200 g of pellets (size of 500/lb) were added to a Heid coater and spun at 15 rpm, diflectors at 3. 8 ml of 8% PVOH was injected, and then immediately 0.364 g of Bermuda grass seed (R6P0), followed by 10.5 g charcoal, followed by 3 ml 8% PVOH, followed by 3 g Zeba®, were added. This resulted in good coating of the pellets, but not as good as the ninth experiment, with only a small amount of charcoal dust and aggregates remaining (4.6 g fine dust charcoal (<1.44 mm) and 6.4 g of small charcoal granules (>1.44 mm with No. 8 screen) remained).

In an eleventh experiment, smooth Brome grass seeds (usually planted at 113,000 seeds/ft) were used. 300 g of pellets (size of 500/lb) were added to a Heid coater and spun at 15 rpm, diflectors at 3. 12 ml of 8% PVOH was injected, and then immediately 4 g of smooth Brome grass seed (to achieve 3 seeds per pellet), followed by 15.75 g charcoal, followed by 4.5 ml 8% PVOH, followed by 4.5 g Zeba®, were added. This resulted in poor coating of the pellets. Not many seeds stuck to the pellets and there was much charcoal dust. But coverage with charcoal fairly good (better than trial 10, but not as good as trial 9). 10.1 g fine dust charcoal (<1.44 mm) and 5.6 g of small charcoal granules (>1.44 mm with No. 8 screen) remained).

In a twelfth experiment, only smooth Brome grass seeds and large pellets were used, to determine how much seed will stick onto the large pellets. 300 g of pellets (size of 500/lb) were added to a Heid coater. 5 ml of 8% PVOH was injected, and then immediately 6.32 g of smooth Brome grass seed (to achieve 5 seeds per pellet), followed by 19 ml 8% PVOH. This resulted in about 70% of the pellets having 1-3 seeds, and about 50% of the seeds stuck to the pellets.

In a thirteenth experiment, charcoal was added to the conditions described for the 12^{th} experiment. 300 g of pellets (size of 500/lb) were added to a Heid coater. 5 ml of 8% PVOH was injected, and then immediately 6.32 g of smooth Brome grass seed (to achieve 5 seeds per pellet), followed by 19 ml 8% PVOH, and 6.15 g of charcoal (for 0.0218 g charcoal per pellet). This resulted in poor coating. There were many seed/charcoal clumps, with few seeds on the pellets.

In a fourteenth experiment, conditions similar to the 9^{th} and 10^{th} experiments were used. 300 g of large pellets were added to a Heid coater and spun at 15 rpm, diflectors at 3. 12 ml of 8% PVOH was injected, and then immediately 6.32 g of Brome grass seed was added, followed by 6.15 g charcoal, followed by 4.5 ml 8% PVOH, followed by 4.5 g Zeba®. This resulted in good coating of the pellets and good seed attachment. Very little seed was left in the coater.

In view of the many possible embodiments to which the principles of the disclosure may be applied, it should be recognized that the illustrated embodiments are only examples of the disclosure and should not be taken as limiting the scope of the disclosure. Rather, the scope of the disclosure is defined by the following claims. I therefore claim as my invention all that comes within the scope and spirit of these claims.

I claim:

1. A composition, comprising:
pelletized coir at least partially coated with seeds and activated charcoal adhered to the pelletized coir by a binder.

2. The composition of claim 1, wherein the pelletized coir is further at least partially coated with a super-absorbent polymer (SAP) adhered to the pelletized coir by a binder.

3. The composition of claim 1, wherein the seeds are at least partially coated with SAP adhered to the seeds by a binder.

4. The composition of claim 1, wherein the binder comprises polyvinyl alcohol or lignosulfanate.

5. The composition of claim 1, wherein the pelletized coir comprises about 1 to 10 adhered seeds.

6. The composition of claim 1, wherein the composition further comprises compost.

7. The composition of claim 1, wherein the SAP comprises about 1.5-2.0% of the weight of the pelletized coir.

8. The composition of claim 1, wherein the pelletized coir does not have cavities greater in diameter than the diameter of the seed.

9. The composition of claim 1, wherein the seeds are not within the pelletized coir.

10. The composition of claim 1, wherein the seeds comprise grass seeds or wildflower seeds.

11. A method of making a planting mix, comprising:
adhering seed and activated charcoal to pelletized coir using a binder, thereby generating a planting mix comprising pelletized coir at least partially coated with a binder, seed, and activated charcoal.

12. The method of claim 11, wherein adhering the seed and activated charcoal to pelletized coir using a binder comprises:
mixing the pelletized coir;
adding a first amount of binder to the pelletized coir;
adding the seed to the first amount of binder and pelletized coir;
adding the charcoal to the seed, first amount of binder and pelletized coir; and
adding a second amount of binder.

13. The method of claim 11, further comprising adhering a super-absorbent polymer (SAP) to the pelletized coir using the binder.

14. The method of claim 13, wherein adhering the seed, activated charcoal and SAP to pelletized coir using a binder comprises:
mixing the pelletized coir;
adding a first amount of binder to the pelletized coir;
adding the seed to the first amount of binder and pelletized coir;
adding the charcoal to the seed, first amount of binder and pelletized coir; and
adding a second amount of binder; and
adding the SAP to the seed, charcoal, first and second amounts of binder and pelletized coir.

15. The method of claim 11, further comprising generating the pelletized coir, wherein generating the pelletized coir comprises:
grinding blocks of coir to achieve about 30 lb/bushel density, thereby generating ground coir; and
milling the ground coir in a California pellet mill to achieve about 46 lb/bushel density, thereby generating pelletized coir.

16. The method of claim 11, further comprising adding compost to the planting mix.

17. The method of claim 13, wherein the SAP comprises about 1.5-2.0% of the weight of the pelletized coir.

18. The method of claim 11, wherein the pelletized coir does not have cavities greater in diameter than the diameter of the seed.

19. The method of claim 11, wherein the seeds are not within the pelletized coir.

20. The method of claim 11, wherein the coated seed-coated bulking agent mixture has increased germination relative to seed alone.
